(19) United States
(12) Patent Application Publication
(10) Pub. No.: US 2025/0277629 A1
(43) Pub. Date: Sep. 4, 2025

(54) A CRYOGENIC COOLING SYSTEM AND METHOD

(71) Applicant: Supernode Limited, Dublin (IE)

(72) Inventors: Deon Volschenk, Dublin (IE); Eoin Hodge, Dublin (IE)

(21) Appl. No.: 18/860,741

(22) PCT Filed: May 4, 2023
(86) PCT No.: PCT/EP2023/061767

§ 371 Date: Oct. 28, 2024

(30) Foreign Application Priority Data
May 5, 2022 (EP) 22171939.6

(51) Int. Cl. F28D 1/02; F28D 21/00

(52) U.S. Cl. CPC F28D 1/0206; F28D 2021/0029; F28D 2021/0033

(57) ABSTRACT

The present invention relates to a cryogenic cooling system and method for particular use in cooling superconducting cables over extended distances, the system and method involving the evaporation of liquid cryogen though an array of spray generators thereby effecting heat transfer utilising the latent heat of vaporisation and optionally through sensible heat transfer in order to provide improved cryogenic cooling over extended distances.

### FIELD OF THE INVENTION

This invention relates to a cryogenic cooling system and method utilising a combination of sensible and evaporative heat transfer, and in particular a cryogenic cooling system and method for use in cooling superconducting cables over extended distances.

### BACKGROUND OF THE INVENTION

Within Superconducting cable systems, at least one electrically conducting element must be maintained at temperatures below the material transition temperature (T_{c}) to enable superconductivity. Superconductor transition temperatures vary from T_{c}<10 K for classic metallic superconductors up to values of T_{c}>100 K for ceramic high-temperature superconductors (HTS).

Superconductors also require stable temperatures during operation to maintain predictable transmission characteristics. As a standard, cryogens such as liquefied gases (Hydrogen, Oxygen, Nitrogen, etc.) are used as cooling mediums to achieve and maintain these temperatures within superconductor systems. Several methods and embodiments of these methods for cooling superconductor current carriers are known in the art.

Standard superconductor cable systems use a forced flow, subcooled, single-phase liquid or gas to absorb and evacuate excess thermal energy through sensible heating and maintain operational temperatures within the specified conductor operational range. The cryogen is circulated within the system to achieve cooling using standard pressurization systems. Excess heat must be removed from the cryogen to maintain a liquefied state for continuous operation and avoid vaporization, which can be achieved through intermittent sub-coolers or cryocoolers. Increased system length necessitates both increased flow rates and system pressures to convey the cryogen which in turn increases the heat load due to the addition of frictional heating. This increases the requirements on heat removal systems and subsequent costs. Over extended distances (>10 km) standard forced flow systems quickly prove uneconomical due to the high costs and low efficiency of the intermittent cooling stations.

Improvements to the state of the art have been proposed to increase the achievable length and improve efficiency through the addition of multiple cooling stages and additional cooling channels in the same cryostat. Standard superconducting cables employ complex insulation systems to improve thermal efficiency. Insulation systems comprise single or multiple layers of insulation material and spacers, in many cases enabled by vacuums (10⁻⁴ to 10³ mbar). Insulation materials include micro and nano porous foams, multi-layer insulation (MLI) comprising combined layers of metallicized material and spacers (to reduce radiation heat loads) and combinations thereof. Further improvements may also be realized by cooling radiation shields in vacuum systems to reduce thermal loads on the primary cooling circuit. These insulation systems are generally capable of achieving thermal loads below 10 W/m².

Maintaining a cryogenic system in a single phase limits the available heat removal to sensible heating of the cryogen through temperature increases only.

It is therefore an object of the present invention to provide an improved cryogenic cooling system and method having particular application in the field of superconducting cables and which achieves heat transfer by means of the latent heat of vaporisation, preferably in combination with sensible heat transfer.

### SUMMARY OF THE INVENTION

According to a first aspect of the present invention there is provided a cryogenic cooling system comprising a medium to be cooled; a liquid channel for carrying a liquid cryogen and arranged such that the medium is in thermal communication with the liquid cryogen; at least one vapour channel adjacent the liquid channel; and a plurality of spray generators communicating between the liquid channel and the at least one vapour channel and operable to effect cooling of the medium by effecting evaporation of the liquid cryogen in response to passage through the spray generators into the at least one vapour channel.

Preferably, the liquid channel comprises a primary liquid channel and a secondary liquid channel surrounding and in fluid communication with the primary liquid channel.

Preferably, the cooling system comprises a pressure generator operable to establish and control a pressure differential between the liquid channel and the at least one vapour channel to drive the liquid cryogen through the spray generators.

Preferably, the spray generators comprise nozzles operable to eject cryogen into the at least one vapour channel.

Preferably, the nozzles are operable to eject vaporised cryogen into the at least one vapour channel.

Preferably, the spray generators are formed integrally with a liquid conduit defining the liquid channel.

Preferably, the cooling system comprises one or more layers of insulation surrounding the at least one vapour channel and/or the liquid channel.

Preferably, the at least one vapour channel is located radially outwardly of the liquid channel.

Preferably, the at least one vapour channel surrounds and encloses the liquid channel.

Preferably, the cooling system comprises a pressure release system operable to facilitate pressure release from the liquid channel into the at least one vapour channel or the environment.

Preferably, the medium is arranged for sensible heat transfer with the cryogen.

Preferably, the medium comprises an extended length of a superconductor extending longitudinally of the liquid channel.

Preferably, the cooling system comprises an outer cryostat surrounding and enclosing the at least one vapour channel.

Preferably, the cooling system comprises a vacuum annulus defined between the outer cryostat and the at least one vapour channel.

Preferably, the cooling system comprises at least one radiation shield in thermal communication with the at least one vapour channel.

Preferably, the at least one radiation shield comprises a conductive sleeve surrounding and thermally contacting the at least one vapour channel.

According to a second aspect of the present invention there is provided a method of cryogenically cooling a medium over an extended distance, the method comprising locating the medium in thermal communication with a liquid channel carrying a supply of liquid cryogen; effecting evaporation of the liquid cryogen into or within at least one vapour channel adjacent the liquid channel via a plurality of spray generators communicating between the liquid channel and the at least one vapour channel in order to absorb heat through the latent heat of vaporisation of the liquid cryogen.

Preferably, the method comprises the step of effecting sensible heat transfer between the medium and the cryogen.

Preferably, the method comprises providing the spray generators as nozzles and effecting evaporation of the liquid cryogen in response to transit through the nozzles into the at least one vapour channel.

Preferably, the method comprises the step of establishing a pressure differential between the liquid channel and the at least one vapour channel to drive the liquid cryogen through the spray generators.

Preferably, the method comprises the step of controlling heat absorption by modulating the mass flow rate of liquid cryogen within the liquid channel.

Preferably, the method comprises the steps of withdrawing vaporised cryogen from the at least one vapour channel, condensing the vaporised cryogen, and recirculating the condensed cryogen into the liquid channel.

### BRIEF DESCRIPTION OF THE DRAWINGS

The present invention will now be described with reference to the accompanying drawings, in which:

FIG. 1 illustrates a cross sectional view of a cryogenic cooling system according to an embodiment of the present invention;

FIG. 2 illustrates a sectioned elevation of the cryogenic cooling system shown in FIG. 1;

FIG. 3 illustrates a cross sectional view of a cryogenic cooling system according to an alternative embodiment of the present invention;

FIG. 4 illustrates a cross sectional view of a cryogenic cooling system according to a further alternative embodiment of the present invention;

FIG. 5 illustrates a cross sectional view of a cryogenic cooling system according to a still further alternative embodiment of the present invention;

FIG. 6 illustrates a cross sectional view of a cryogenic cooling system according to a further embodiment of the present invention, being a variant of the system of FIG. 1 with multiple discrete vapour channels;

FIG. 7 illustrates a cross sectional view of a cryogenic cooling system according to a further embodiment of the present invention, being a variant of the system of FIG. 3 with multiple discrete vapour channels;

FIG. 8 illustrates a cross sectional view of a cryogenic cooling system according to a further embodiment of the present invention, being a variant of the system of FIG. 4 with multiple discrete vapour channels;

FIG. 9 illustrates a cross sectional view of a cryogenic cooling system according to a further embodiment of the present invention, being a variant of the system of FIG. 5 with multiple discrete vapour channels;

FIG. 10 illustrates a cross sectional view of a modification to the cryogenic cooling system of FIG. 6;

FIG. 11 illustrates a cross sectional view of a modification to the cryogenic cooling system of FIG. 7;

FIG. 12 illustrates a cross sectional view of a modification to the cryogenic cooling system of FIGS. 8; and

FIG. 13 illustrates a cross sectional view of a modification to the cryogenic cooling system of FIG. 9.

### DETAILED DESCRIPTION OF THE DRAWINGS

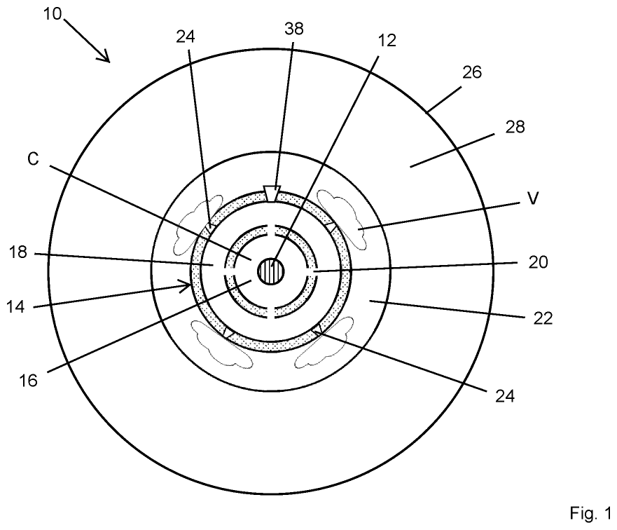

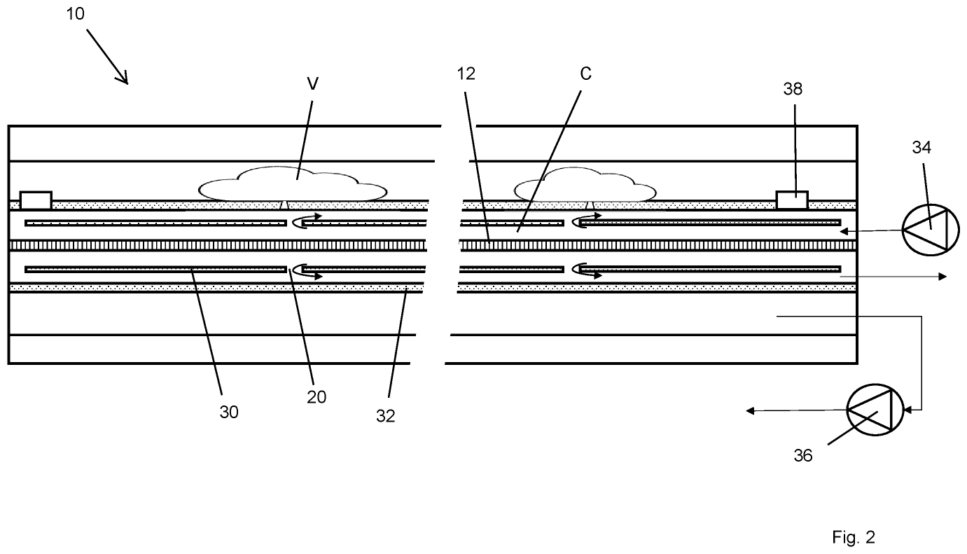

Referring now to FIGS. 1 and 2 of the accompanying drawings there is illustrated a cryogenic cooling system, generally indicated as 10, for use in cooling a medium such as a superconductor 12 over extended lengths, for example 10 km or more, and thus having particular application in long-distance onshore and subsea superconducting electrical transmission systems. While the cooling system 10 of the invention is primarily intended for use in superconductor architectures it may be applied to any industry where stable, low flow and economical cryogenic cooling solutions are required. This includes but is not limited to aerospace instruments, electronics and sensor cooling systems, superconductor magnet systems, and cooling systems for liquefied cryogens such as hydrogen and LNG within the energy supply and transport industry, where one or more cryogen May comprises the medium to be cooled.

The cooling system 10 comprises a liquid channel 14 within which the superconductor 12 extends longitudinally, the liquid channel 14 comprising a primary liquid channel 16 and a secondary liquid channel 18 concentrically surrounding the primary channel 16. A number of ports 20 permit liquid communication and therefore the flow of liquid cryogen C between the primary and secondary liquid channels 16, 18. It will be appreciated that any alternative functional arrangement may be provided to enable this fluid communication. It is also envisaged that a single liquid channel may be provided in place of the primary and secondary channels 16, 18. The cryogen C may for example comprise liquid hydrogen, nitrogen or helium, although it is envisaged that any other liquid cryogens or combinations thereof may be utilised. The liquid cryogen C is supplied to the liquid channel 14 from any suitable external source (not shown). The secondary flow channel 18 may also act as a return path for the liquid cryogen C, whether to the external source or downstream processing systems (not shown) to suitably condition the cryogen before reintroduction into the primary liquid channel 16.

In the preferred embodiment illustrated the superconductor 12 is preferably located concentrically within the primary liquid channel 16, fully immersed in the liquid cryogen C and thus enabling the sensible transfer of heat between the cryogen C and the superconductor 12. It will of course be understood that the superconductor 12 may be provided in any other suitable position/orientation within or about the liquid channel 14, whether the primary channel 16 and/or the secondary liquid channel 16 and for example as exemplified in alternative embodiments described hereinafter. The superconductor 12 may also be provided in any suitable configuration, for example comprising multiple elements (not shown) or the like. The superconductor 12 may be configured to conduct single pole or multipole direct current (DC) or single phase or multiphase alternating current (AC), and may be physically arranged on concentric axes (for example a tri-axis arrangement in a three phase system) or adjacent axes (a tri-ad arrangement for a three phase system).

Surrounding and enclosing the liquid channel 14 is a vapour channel 22, with an array of spray generators 24 arranged in a discrete manner along the length of the system 10, communicating between the liquid channel 14 and the vapour channel 22 and operable to effect vaporisation of the liquid cryogen into the vapour channel 22 as described hereinafter in detail. Within the secondary liquid channel 18, a percentage of the cryogen C may be returned to the external cryogen source (not shown) while the remainder is siphoned off and dispersed through the spray generators 24 to undergo a phase transition within the spray generators 24 and/or the vapor channel 22 on exiting the spray generators 24. The primary function of the spray generators 24 is to aid the evaporation process through dispersion of the liquid cryogen C. In the preferred embodiment illustrated each spray generator 24 comprises a nozzle 24 which is adapted to effect the vaporisation of a flow of the liquid cryogen passing through the nozzle 24 from the liquid channel 14 into the vapour channel 22. The spray generators 24 may however comprise one or several elements in combination (such as atomizers, nozzles, orifices, etc.) which aid the mechanism of evaporation through cryogen droplet aerosolization and/or atomization. The nozzles 24 may be discrete components or may be formed integrally with the liquid channel 14, and may for example be formed from the same material, for example metallic, a polymer or a composite material.

The rate of evaporation and flow rate through the nozzles 24 may be controlled by a combination of differential pressure and/or nozzle geometry. Evaporation may occur either partially within the nozzle 24, at the interface of the nozzle 24 and the vapour channel 22 or entirely within the vapour channel 22. The vaporised cryogen V collected in the vapour channel 22 may be partially or fully extracted, condensed and recirculated into the liquid channel 14. Additionally or alternatively the vaporised cryogen V may be vented to the atmosphere.

The cooling system 10 additionally comprises an outer cryostat 26 surrounding and enclosing the vapour channel 22 and preferably defining a vacuum annulus 28 between the cryostat 26 and vapour channel 22. In use the vacuum drawn in the vacuum annulus 28 reduces thermal convection in the cryogenic cooling system 10, and in the embodiment illustrated may be in the range of between 10⁻³ and 1000 Pa, more preferably between 10⁻³ and 10 Pa although alternative vacuum levels may employed. It is also to be understood that additional or alternative layers or forms of insulation may be provided as part of the cryogenic cooling system 10 as are well known in the art. These layers may be located at various suitable locations or layers within the system 10. For example a first layer 30 of physical insulation is preferably provided between the primary liquid channel 16 and the secondary liquid channel 18, and a second layer 32 of physical insulation between the secondary liquid channel 18 and the vapour channel 22 to reduce thermal bridging therebetween.

Referring to FIG. 2, the cooling system 10 preferably additionally comprises a pressure generator operable to establish a pressure differential between the liquid channel 14 and the vapour channel 22, in the radial direction, such as to drive liquid cryogen C from the liquid channel 14, through the nozzles 24 to undergo evaporation into the vapour channel 22. The pressure generator for example comprises a first pump 34 operable to affect forced flow of the liquid cryogen C through the liquid channel 14 at an elevated pressure, and a second pump 36 operable to withdraw the vaporised cryogen V from within the vapour channel 22. Any other functional alternative to the first and second pumps 34, 36 may of course be employed to establish the requisite pressure differential between the liquid channel 14 and the vapour channel 22.

The vaporised cryogen V may then be condensed for reintroduction to the liquid channel 14 for further cooling of the system 10, or may be vented to the atmosphere or otherwise processed. The cooling system 10 may be operable to affect either complete or partial boil-off of the cryogen. This may reduce or eliminate the number of intermittent cooling stations (not shown) required thereby reducing the capital cost and electrical energy consumption of the cooling system 10, leading to improved efficiency. The pressure generator may also be utilised to modulate the heat absorption rate within the system 10 by controlling the mass flow rate of liquid cryogen C within the liquid channel 14.

The first and second pumps 34, 36 may be operated to establish any necessary pressure differential between the liquid channel 14 and the vapour channel 22, for example in the range of between 1 bar and 25 bar, although this may vary depending on operating conditions or other parameters such as the number and/or configuration of the nozzles 24, the selected cryogen, operating length of the superconductor 12, etc. For example the first pump 34 may establish a pressure differential of between 10 bar and 25 bar in the liquid cryogen C in the liquid channel 14 while the second pump 36 may be operable to establish a pressure of around 1 bar in the gaseous cryogen V in the vapour channel 22.

During operation of the cooling system 10 heat leaks from the environment or frictional heat may result in bubble formation in the liquid cryogen C increasing internal pressure. Thus, in particular in long-distance applications, pressure relief may be achieved via a pressure relief system 38 to release unwanted pressure in the liquid cryogen C by providing an additional pathway into the vapour channel 22 from the liquid channel 14, which may for example be operable once a threshold pressure is reached in the liquid cryogen C.

The cooling system 10 of the present invention is thus operable to achieve cryogenic cooling by extracting heat via the latent heat of vaporisation of the liquid cryogen C and optionally in combination with sensible heat transfer into the liquid cryogen C. It is well documented that phase changes (solid to liquid or liquid to gas) require significantly greater energy inputs (200 KJ/kg for liquid nitrogen, 512 KJ/kg for liquid methane) while occurring at a constant temperature, dependent only on the fluid pressure. The latent heat of vaporization of a cryogen presents a method for removing significantly greater amounts of heat from the cooling system 10 at lower flow rates than those required when using sensible heat transfer only.

By providing the vapour channel 22 as an outer layer surrounding the conductor 12 and liquid channel 14, the cooling system 10 provides an effective distribution of vapour generation sites around the liquid channel 14 while simultaneously allowing the vapour channel 22 to function as an insulating layer maintained at a controlled pressure. By locating the superconductor 12 out of the path of vapour formation, within the liquid channel 14, issues such as pitting or other damage can be avoided.

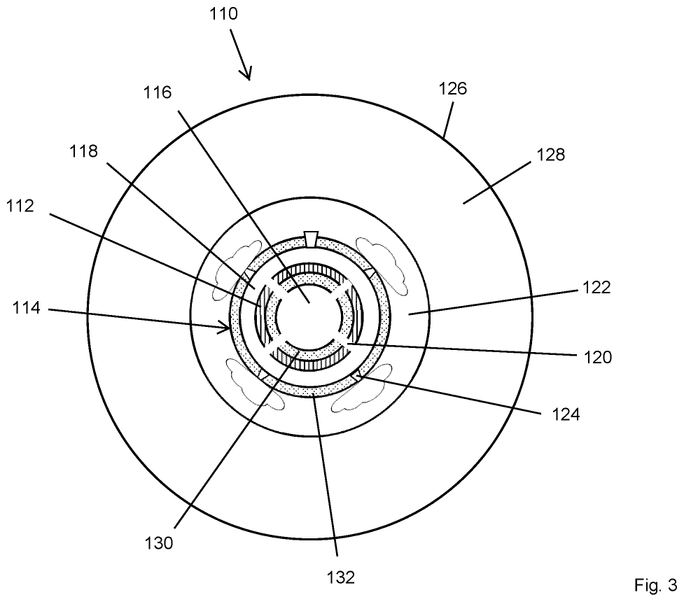

Referring now to FIG. 3 there is illustrated a second embodiment of a superconducting cable cooling system according to the invention and generally indicated as 110. In this second embodiment like components have been accorded like reference numerals and unless otherwise stated perform a like function. The cooling system 110 comprises a superconductor 112 and a liquid channel 114 containing a liquid cryogen C and within which the superconductor 112 is contained. The liquid channel 114 comprises a primary liquid channel 16 and a concentrically surrounding secondary channel 118. A number of ports 120 permit liquid communication between the primary and secondary liquid channels 116, 118. The superconductor 112 is however annular in cross section, and is located within the secondary liquid channel 118 and circumscribing the primary liquid channel 116. The superconductor 112 is preferably surrounding and/or mounted in physical contact with a first layer 130 of insulation disposed between the primary and secondary liquid channels 116, 118. The ports 120 extend through this first layer 130 of physical insulation and through the superconductor 120 in order to facilitate flow of the liquid cryogen C between the primary and secondary liquid channels 116, 118. The superconductor 112 may therefore comprises multiple sections with adjacent sections being separated from one another to partially define the respective port 120.

As with the first embodiment the cooling system 110 comprises a vapour channel 122 surrounding and enclosing the liquid channel 114, a plurality of spray generators in the form of nozzles 124 communicating between the fluid channel 114 and the vapour channel 122. The nozzles 124 are operable to generate vaporisation of a portion of the liquid cryogen C into the vapour channel 122 in order to extract heat via the latent heat of vaporisation, preferably under a pressure differential as hereinbefore described in relation to the first embodiment. A second layer 132 of physical insulation is preferably located between the liquid channel 114 and the vapour channel 122 in order to reduce thermal bridging. The vapour channel 122 is then enclosed within an outer cryostat 126 defining a vacuum annulus 128.

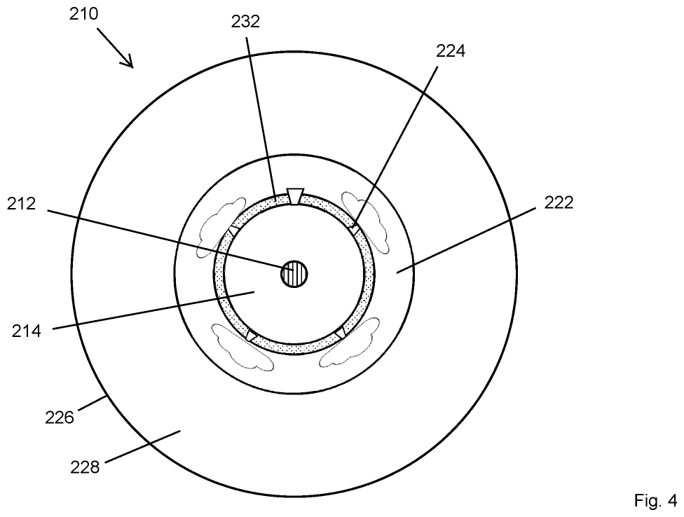

Referring to FIG. 4 there is illustrated a third embodiment of a cooling system according to the invention and generally indicated as 210, for particular application in the cryogenic cooling of superconductors over extended distances to facility the transmission of electrical energy. Again in this third embodiment like components have been accorded like reference numerals and unless otherwise stated perform a like function. The cooling system 210 comprises a centrally located superconductor 212 within a single liquid channel 214 containing a liquid cryogen C and within which the superconductor 212 is fully immersed and in direct thermal communication.

The cooling system 210 further comprises a vapour channel 222 surrounding and enclosing the liquid channel 214, a plurality of spray generators in the form of nozzles 224 communicating between the fluid channel 214 and the vapour channel 222. The nozzles 224 are operable to generate vaporisation of a portion of the liquid cryogen into the vapour channel 222 in order to extract heat via the latent heat of vaporisation, preferably under a pressure differential as hereinbefore described. A layer 232 of physical insulation is preferably located between the liquid channel 214 and the vapour channel 222. The vapour channel 222 is then enclosed within an outer cryostat 226 defining a vacuum annulus 228.

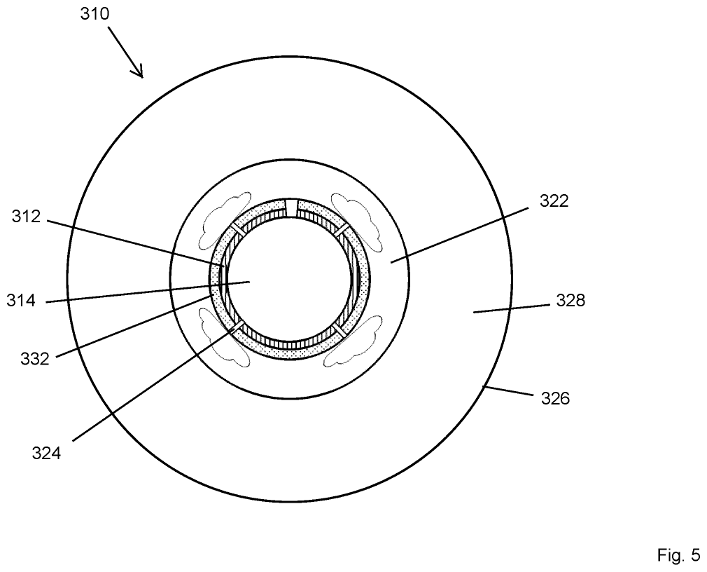

Referring to FIG. 5 there is illustrated a fourth embodiment of a superconducting cable cooling system according to the invention and generally indicated as 310. Like components have been accorded like reference numerals and unless otherwise stated perform a like function. The cooling system 310 comprises a superconductor 312 and a single liquid channel 314 containing a liquid cryogen C. The superconductor 312 is annular in cross section and circumscribes the liquid channel 314, preferably surrounded by a layer 332 of physical insulation.

The cooling system 310 comprises a vapour channel 322 surrounding and enclosing the liquid channel 314, a plurality of spray generators in the form of nozzles 324 communicating between the fluid channel 314 and the vapour channel 322. The nozzles 324 are operable to generate vaporisation of a portion of the liquid cryogen C into the vapour channel 322 in order to extract heat via the latent heat of vaporisation, preferably under a pressure differential. A layer 332 of physical insulation is preferably located between the liquid channel 314 and the vapour channel 322. The nozzles 324 extend through this layer 332 of physical insulation and through the superconductor 312. The superconductor 312 may therefore comprises multiple sections with adjacent sections being separated from one another to accommodate the respective nozzle 324. The vapour channel 322 is then enclosed within an outer cryostat 326 defining a vacuum annulus 328.

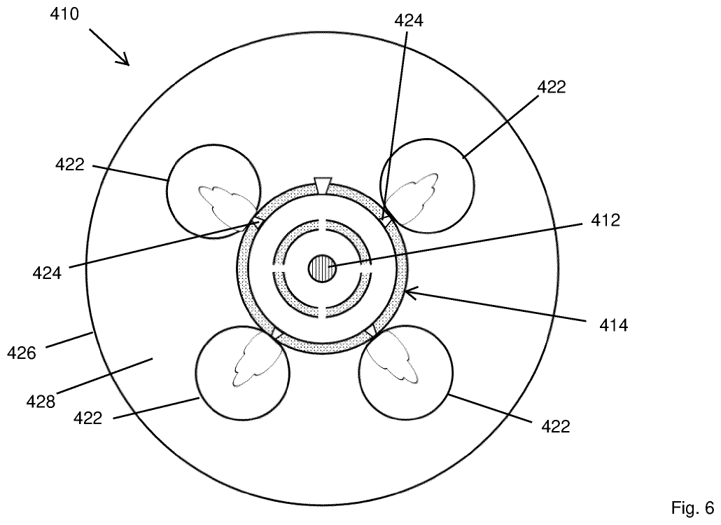

FIG. 6 illustrates a further alternative embodiment of a cryogenic cooling system according to the present invention and generally indicated as 410. Like components have been accorded like reference numerals and unless otherwise stated perform a like function. The cooling system 410 mirrors the configuration of the system 10 illustrated in FIG. 1, with one significant difference. The system 410 comprises a plurality of discrete vapour channels 422 located adjacent and radially outwardly of a liquid channel 414, in contrast to the single circumscribing vapour channel of the system 10 of FIG. 1. All other aspects of the cooling system 410 are identical to the cooling system 10, and which operates in essentially the same manner to cool a superconductor 412 therein. In the arrangement illustrated four of the discrete vapour channels 422 are provided, each communicating with the liquid channel 414 via one of four nozzles 424. The nozzles 424 are operable to achieve cooling of the superconductor 412 by effecting evaporation of the liquid cryogen in response to passage through each nozzle 424 into the respective vapour channel 422 as hereinbefore described. It will be appreciated that the number, size, shape and particular configuration of the vapour channels 422 may be varied as required. The cooling system 410 likewise comprises an outer cryostat 426 surrounding and enclosing the vapour channels 422 and again preferably defining a vacuum annulus 428 between the cryostat 426 and vapour channels 422.

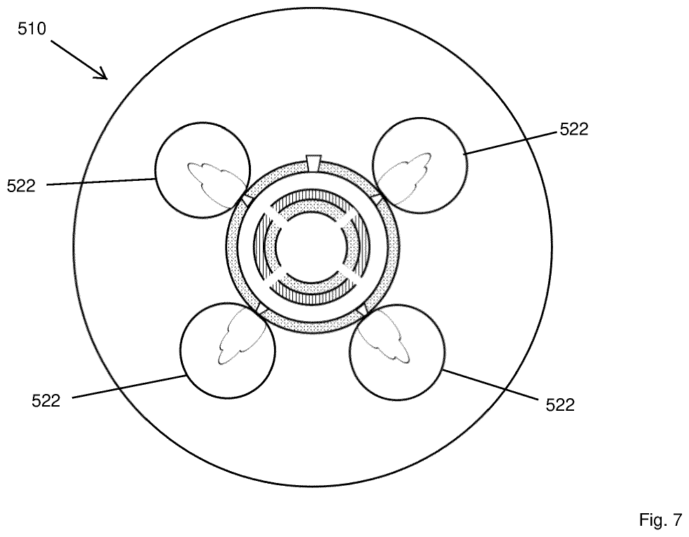

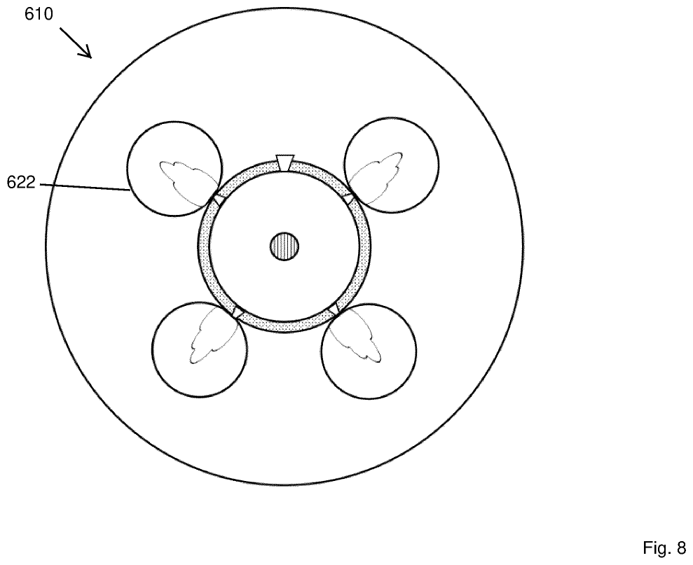

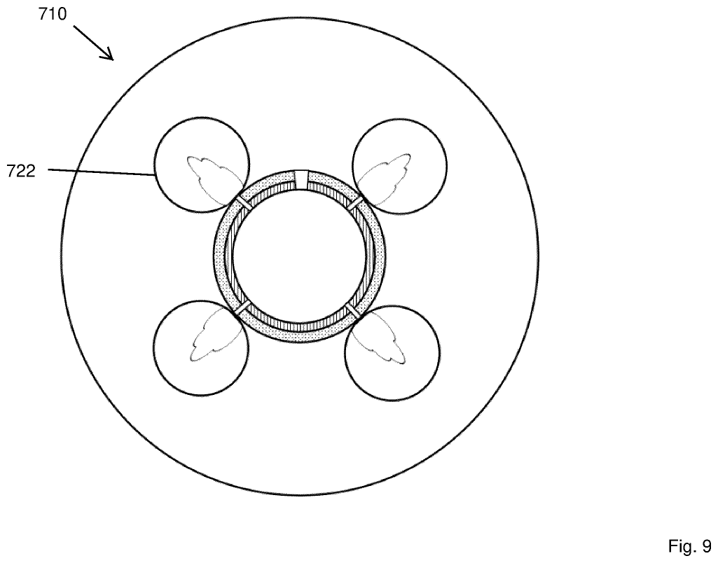

Referring to FIG. 7 a further related embodiment of a cryogenic cooling system according to the present invention is illustrated, and generally indicated as 510. Like components have been accorded like reference numerals and unless otherwise stated perform a like function. The cooling system 510 mirrors the configuration of the system 110 illustrated in FIG. 3, but with the same modification as detailed above in relation to the system 410 shown in FIG. 6, namely the provision of a plurality of discrete vapour channels 522. Similarly FIG. 8 illustrates an embodiment of a cooling system according to the present invention, generally indicated as 610, which mirrors the configuration of the system 210 illustrated in FIG. 4, with the same modification to incorporate a plurality of discrete vapour channels 622. FIG. 9 illustrates an embodiment of a cooling system according to the present invention, generally indicated as 710, which mirrors the configuration of the system 310 illustrated in FIG. 5, but incorporating a plurality of discrete vapour channels 722 in place of the single circumscribing element of FIG. 5. All other aspects and operation are equivalent.

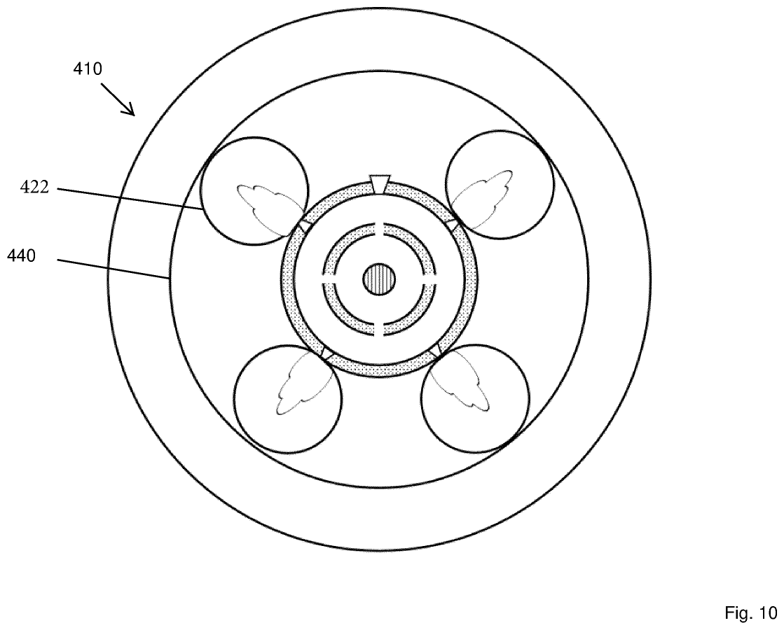

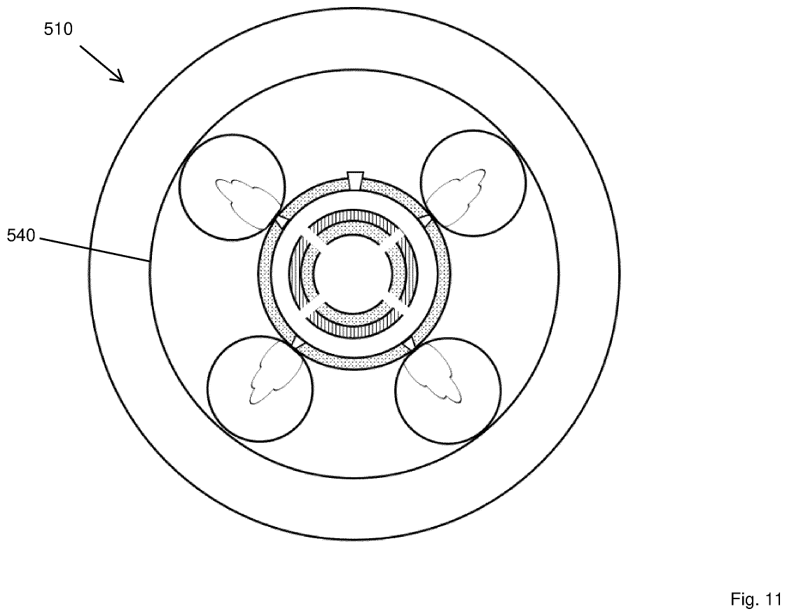

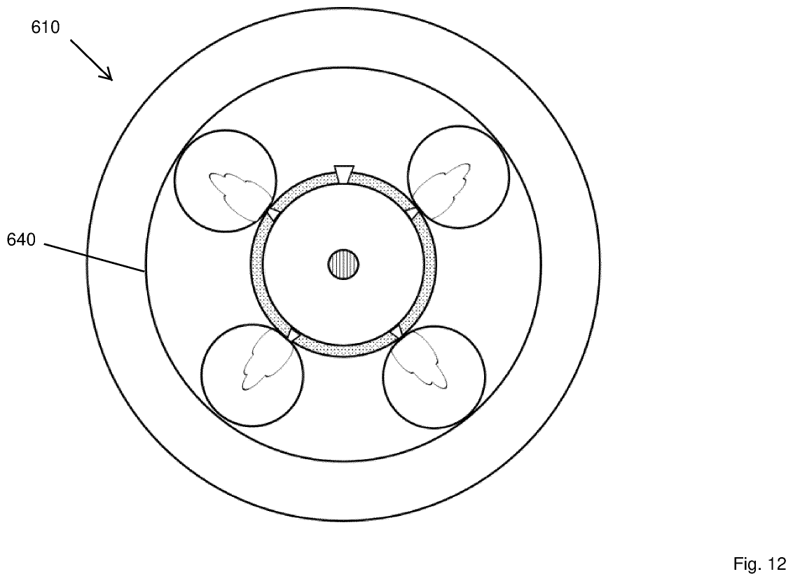

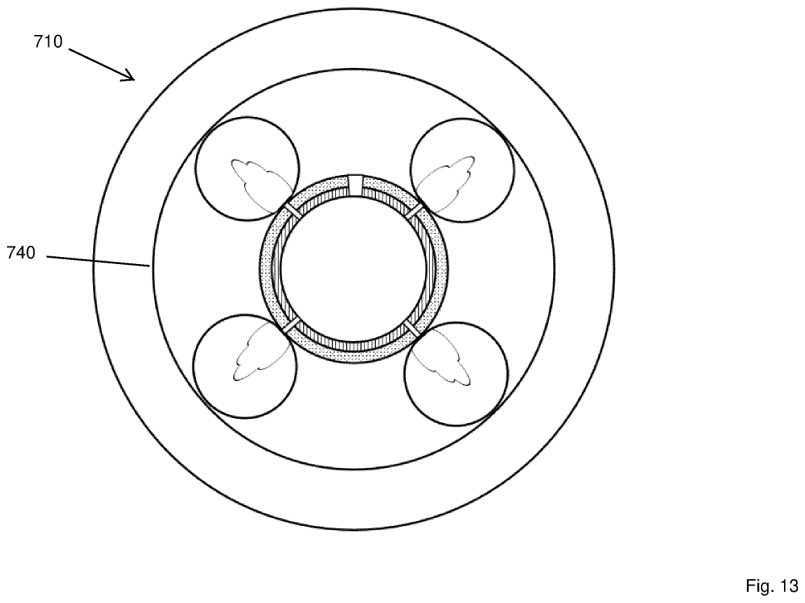

Turning to FIGS. 10 to 13 the cooling systems 410; 510; 610; 710 as illustrated in FIGS. 6 to 9 are modified to provide improvements in thermal performance by utilizing the gaseous cryogen as a secondary coolant for a radiation shield 440; 540; 640; 740 forming part of the cooling system 410; 510; 610; 710. The radiation shield 440; 540; 640; 740 preferably comprises a thermally conductive sleeve surrounding the vapour channels 422; 522; 622; 722 and being in conductive and preferably physical contact therewith. In this way thermal transfer from the radiation shield 440; 540; 640; 740 to the vapour channels 422; 522; 622; 722 and ultimately to the vaporised cryogen can occur in order to facilitate temperature control of the radiation shield 440; 540; 640; 740. Radiative heat transfer within one or more layers of vacuum insulation holds a fourth power relationship with temperature. Small reductions in thermal shield temperature can result in large thermal efficiency gains within the overall system of the invention.

By utilizing both the latent heat of vaporization and sensible heating of the cryogen C (for gas and liquid), the cooling system 10; 110; 210; 310 of the invention allows up to twenty times more heat removal per unit of cryogen than standard sensible heating solutions known in the art. This results in up to a twenty fold reduction (approx. 0.25 kg/s compared to 5 kg/s for 100 kW heat removal) in mass flow rate requirements for the cooling system of the invention compared to the known standard solutions and subsequently lower pressure requirements. The reduction in pressure and flow requirements result in longer achievable lengths for the superconductor or other medium to be cooled (for example greater than 10 km). The cooling system 10; 110; 210; 310 of the invention applies evaporative heat absorption through the primary mechanism of evaporation but may also employ mechanisms including Joule-Thompson cooling and sensible heat transfer to both the liquid cryogen C and gaseous cryogen V.

The cooling system 10; 110; 210; 310 of the present invention offers additional flexibility in that boil-off cryogen may be fully utilized for heat absorption and re-liquefaction at evacuation areas or discarded to the atmosphere. The lower flow rate and larger operational temperature range (cryogen is not limited to a 10K temperature difference) of the invention offers greater thermal stability within the system 10; 110; 210; 310 leading to a more robust solution for long-distance onshore and subsea transmission systems.

Improvements to the cooling system of the invention may also be realized through variable system properties such as nozzle or orifice size and spacing along the length of the system to optimize flow patterns and the atomization of the cryogen.

The system of the invention may also employ variable cryostat diameters the length of the system to account for improvements in flow and pressure characteristics as liquid cryogen evaporates. The system may also make use of valves (not shown) or discrete geometrical obstructions to limit flow between primary and secondary liquid channels in order to control system pressure distribution.

The invention is not limited to the embodiments described herein but can be amended or modified without departing from the scope of the present invention.

1. A cryogenic cooling system comprising a medium to be cooled; a liquid channel for carrying a liquid cryogen and arranged such that the medium is in thermal communication with the liquid cryogen; at least one vapour channel adjacent the liquid channel; and a plurality of spray generators communicating between the liquid channel and the at least one vapour channel and operable to effect cooling of the medium by effecting evaporation of the liquid cryogen in response to passage through the spray generators into the at least one vapour channel.

2. The cryogenic cooling system of claim 1 wherein the liquid channel comprises a primary liquid channel and a secondary liquid channel surrounding and in fluid communication with the primary liquid channel.

3. The cryogenic cooling system of claim 1 comprising a pressure generator operable to establish and control a pressure differential between the liquid channel and the at least one vapour channel to drive the liquid cryogen through the spray generators.

4. The cryogenic cooling system of claim 1 in which the spray generators comprise nozzles operable to eject cryogen into the at least one vapour channel.

5. The cryogenic cooling system of claim 4 in which the nozzles are operable to eject vaporised cryogen into the at least one vapour channel.

6. The cryogenic cooling system of claim 1 in which the spray generators are formed integrally with a liquid conduit defining the liquid channel.

7. The cryogenic cooling system according to claim 1 comprising one or more layers of insulation surrounding the at least one vapour channel and/or the liquid channel.

8. The cryogenic cooling system according to claim 1 in which the at least one vapour channel is located radially outwardly of the liquid channel.

9. The cryogenic cooling system according to claim 1 in which the at least one vapour channel surrounds and encloses the liquid channel.

10. The cryogenic cooling system according to claim 1 comprising a pressure release system operable to facilitate pressure release from the liquid channel into the at least one vapour channel or the environment.

11. The cryogenic cooling system according to claim 1 in which the medium is arranged for sensible heat transfer with the liquid cryogen.

12. The cooling system according to claim 1 in which the medium comprises an extended length of a superconductor extending longitudinally of the liquid channel.

13. The cryogenic cooling system according to claim 1 comprising an outer cryostat surrounding and enclosing the at least one vapour channel.

14. The cryogenic cooling system according to claim 13 comprising a vacuum annulus defined between the outer cryostat and the at least one vapour channel.

15. The cryogenic cooling system according to claim 1 comprising at least one radiation shield in thermal communication with the at least one vapour channel.

16. The cryogenic cooling system according to claim 15 in which the at least one radiation shield comprises a conductive sleeve surrounding and thermally contacting the at least one vapour channel.

17. A method of cryogenically cooling a medium over an extended distance, the method comprising locating the medium in thermal communication with a liquid channel carrying a supply of liquid cryogen; effecting evaporation of the liquid cryogen into or within at least one vapour channel adjacent the liquid channel via a plurality of spray generators communicating between the liquid channel and the at least one vapour channel in order to absorb heat through the latent heat of vaporisation of the liquid cryogen.

18. A method according to claim 17 comprising the step of effecting sensible heat transfer between the medium and the cryogen.

19. A method according to claim 17 comprising providing the spray generators as nozzles and effecting evaporation of the liquid cryogen in response to transit through the nozzles into the at least one vapour channel.

20. A method according to claim 17 comprising the step of establishing a pressure differential between the liquid channel and the at least one vapour channel to drive the liquid cryogen through the spray generators.

21. A method according to claim 17 comprising the step of controlling heat absorption by modulating the mass flow rate of liquid cryogen within the liquid channel.

22. A method according to claim 17 comprising the steps of withdrawing vaporised cryogen from the at least one vapour channel, condensing the vaporised cryogen, and recirculating the condensed cryogen into the liquid channel.
